(19) United States
(12) Patent Application Publication
(10) Pub. No.: US 2007/0231730 A1
(43) Pub. Date: Oct. 4, 2007

(54) Radiation Curable Toner Composition

(75) Inventors: Werner Op de Beeck, Putte (BE); Lode Deprez, Wachtebeke (BE); Michel Vervoort, Gierle (BE)

Correspondence Address: BACON & THOMAS, PLLC, 625 SLATERS LANE, FOURTH FLOOR, ALEXANDRIA, VA, 22314, US

(73) Assignee: PUNCH GRAPHIX INTERNATIONAL N.V.

(21) Appl. No.: 11/597,401

(22) PCT Filed: May 26, 2005
(86) PCT No.: PCT/BE05/00085

§ 371 Date: Nov. 24, 2006

(30) Foreign Application Priority Data
May 26, 2004 (GB) 0411774.3

(51) Int. Cl. G03G 9/00; G03B 27/02; G03C 1/00; G03G 5/00

(52) U.S. Cl. 430/110.4; 355/78; 430/110.1; 430/111.1; 430/137.21; 430/495.1

(57) ABSTRACT

The invention relates to dry toner particles comprising at least a radiation curable resin and a colouring agent, the radiation curable resin comprises a blend of a) an (meth)acrylated epoxy/polyester resin b) (meth)acrylated polyurethane resin. Preferably, when fused and cured toner images obtainable from said dry toner particles are obtained on a substrate used for developing same, these images have an equivalent rub number (ERN)>6, wherein ERN=MEK rub resistance/(radiation dose*meq/gr), wherein meq/gr designates the milli-equivalent amount of double bounds per gram of said radiation curable resin and a viscosity behaviour such that the viscosity at 140° C. is lower than the viscosity at 120° C.

The present invention relates to improved radiation curable toner compositions, in particular UV-curable toner particles for use in such compositions, as well as to improved dry developer compositions and methods of printing using the toner or developer compositions. The present invention also relates to a more efficient method of fusing and curing dry toner particles, and to substrates printed with a toner comprising said improved radiation curable toner compositions.

### BACKGROUND OF THE INVENTION

In imaging methods like electro(photo)graphy, magnetography, ionography, etc. a latent image is formed which is developed by attraction of so called toner particles. Afterwards the developed latent image (toner image) is transferred to a final substrate and fused to this substrate. In direct electrostatic printing (DEP) printing is performed directly from a toner delivery means on a receiving substrate by means of an electronically addressable print head structure.

Toner particles are basically polymeric particles comprising a polymeric resin as a main component and various ingredients mixed with said toner resin. Apart from colourless toners, which are used e.g. for finishing function, the toner particles comprise at least one black and/or colouring substances, e.g., coloured pigment.

Originally, colour electro(photo)graphy was mostly used for producing coloured images (e.g. graphic arts, presentations, coloured books, dissertations, etc.). When the process speed of producing digital coloured images increased, other more productive applications also came into the picture (direct mailing, transactional printing, packaging, label printing, security printing, etc.). This means that after the operation of being produced by electro(photo)graphy, the toner images further have to withstand some external factors applied during the subsequent treatments. The problems associated with multiple, superimposed layers of toner particles that are in one way or another fixed on a substrate are manifold, not only with respect to image quality but also with respect to image stability and with respect to mechanical issues.

An example of high mechanical impact on the toner layers is the sorting of printed papers (e.g. direct mail applications). The fast turning wheels of a sorting machine can give a temperature increase above the glass transition temperature (Tg) of the resin used, that can cause contamination with pigmented toner resin on the next coming papers. Another application where the heat and mechanical resistance of the toner layer is stressed is the production of e.g. car manuals. When the temperature inside the car rises above the Tg of the toner resin (e.g. when parked in the sun), the papers in the manual can stick to each other.

Another example of limited mechanical strength of conventional toner is the breaking of the toner layer during folding of the printed matter due to the brittleness of the toner layer.

In the case of printing packaging materials with the use of toner technology, increased temperatures are met in many ways. Plastic can be used as a substrate and bags made out of it with the use of a sealing apparatus. If the sealing temperature is above the Tg of the toner resin used, the toner images get disturbed or perturbed. Other requirements of the printed matter in the field of packaging are the retortability, where the toner has to withstand a temperature of 121° C. for 30 minutes in a 100% humidity environment (equivalent to a sterilization process for food) and a wrinkle test called the gelboflex test where the printed material is torsioned 20 times. With conventional toner the toner will peel off or the image gets completely disturbed.

For a lot of these applications, a toner resin with a higher Tg and Tm should be used, but then the amount of energy necessary to fuse the toner particle onto the substrate would be so high that the application is energetically not interesting anymore. Secondly a lot of substrates can't be used anymore. High Tg toners exist already, but the demand for high speed engines increases the demand for toner particles which can be fused at normal temperatures at a very high speed.

All the above requirements can be solved by using a radiation curable toner known per se from the literature.

The use of a transparent cover coat made out of radiation curable toner particles has been described already in e.g. U.S. Pat. No. 5,905,012 to protect an image produced by electrophotography to thereby improve the weather resistance of an image produced by means of electrophotography.

A non-image-wise transparent UV curable coating has been described already in EP-A-1.288.724 to give a flexible, high gloss finishing to printed papers. Prints obtained by means of electrophotography and by the use of thermally fixable toner are thermal stable only to approximately 100° C. Packaging materials must however partly be heated to temperatures far above 100° C. during the production of sealed packaging. Thus for example for sealable packaging, a completely transparent, heat resistant coat layer from a toner hardening by UV light has been described in EP 1,186,961.

In EP1,341,048 a process is described for cross linking an unsaturated polyester under UV light.

In U.S. Pat. No. 6,461,782 a UV curable toner is described based on a cationic UV curable polymer in order to improve the mechanical resistance of the image when fusing at low temperatures.

The use of UV curable pigmented powders is already well known in the field of powder coatings (e.g. EP 792,325), but there are some major differences with respect to the field of toner. The size of the particles (6-10 microns for toner versus>30 microns for powder coatings) and the particle size distribution are quite different. Also the thickness of the layers applied with powder coatings is at least a factor 3 to 4 times thicker in comparison with the toner images. The speed of fusing and curing is very low (compared to the high speed printers which are now available in the field (e.g. Igen3, Xeikon 5000, etc.). Powder coatings are also not applied image wise. The powders are charged by some means and brought onto the surface of the material, which has to be coated. This is all quite different from toner, which is brought either directly image wise on a substrate, or via a latent image on a photoconductor to a substrate.

In U.S. Pat. No. 5,212,526 an UV curable liquid toner has been described to improve the adhesion of the cured toner to the final substrate rather than to the surface of the image receptor during the transfuse step instead of withstanding to high temperatures. The curing here takes place during the transfer step from photoreceptor to paper.

It is however also important that an optimal curing efficiency can be established under different printing conditions like different printing speeds, different substrates and different layer thickness and colours. The speed of the digital print engines is still increasing and also the number of substrates is manifold especially when printing from web. Paper from 40 to 400 gsm as well as heat sensitive foils like PE, PP and PVC from 10 to 400 gsm as well as metallic foils from 5 to 400 gsm can be used.

Also the layer thickness can vary a lot. In the field of digital printing all combinations from 0% for CMYKX up to 100% for all CMYKX are possible. This means that the layer thickness can vary from 10 to 40 μm depending on the particle size of the toner. The curing efficiency off all the different colours needs to be equal.

From all those references only a general description of radiation curable toner is found and a highly performing radiation curable toner under different printing conditions is still not attainable with the above teachings.

There is a need in the art for toner particles that provide an improved mechanical and/or thermal strength, for example with a significantly improved rub resistance at curing to the images developed therefrom.

### OBJECTS OF THE INVENTION

It is an object of the invention to provide a method of manufacture and a toner with a high curing efficiency under different printing conditions

It is a further object of the invention to provide a method of manufacture and a toner to produce images that are very resistant to high temperatures, mechanical abrasion and organic solvents.

It is a further object of the invention to provide a method of manufacture and a toner with good electro photographical properties like chargeability, viscosity, lifetime performance.

Further objects and advantages of the present invention will become evident from the detailed description hereinafter.

### SUMMARY OF THE INVENTION

In accordance with the present invention a radiation curable toner is provided comprising at least a radiation curable binder, optionally a photo initiator and a pigment or colouring agent. The radiation curable resin comprises a blend of a (meth)acrylated polyester resin and a meth(acrylated) polyurethane resin.

Preferably, the radiation curable resin comprises a blend of a) a (meth)acrylated epoxy/polyester resin b) a (meth)acrylated polyurethane resin. Said toner particles may provide an equivalent rub number (ERN)>6, wherein ERN=MEK rub resistance/(radiation dose*meq/gr), wherein meq/gr designates the milli-equivalent amount of double bounds per gram of said radiation curable resin They preferably have a viscosity behaviour such that the viscosity at 140° C. is lower than the viscosity at 120° C. Preferably, dry toner particles of the invention are such that (ERN)>10 when the substrate used for developing said toner images is heated between 100° C. and 160° C. at the time of curing. In one preferred embodiment, the (meth)acrylated expoxy/polyester resin is based on terefthalic acid and neopentyl glycol. (Meth)acrylated polyurethane resin is a polyesterurethane (meth)acrylate resin, or acylate resin. The resin may be an electron-beam curable resin, or UV-light curable resin. The toner particles may further comprise one or more photoinitiators, as well as a flowability improving agent.

Preferably, the milli-equivalent amount of double bounds per gram of said radiation curable resin is >1 meq/gr. According to a preferred embodiment, the dry toner paticles have g a volume average diameter between 3 and 20 μm. It is preferred that the particle size distribution is characterised by a coefficient of variability smaller than 0.5.

The particles according to the invention preferably have a viscosity of the toner particles is between 50 and 5,000 Pa·s at 120° C. The MEK rub resistance of the cured toner images is preferably higher than 100 rubs.

In a most preferred embodiment, the blend ratio (a)/(b) varies between 92.5/7.5 and 50/50.

The invention also covers dry electrostatographic developer composition comprising carrier particles and toner particles as defined above. This composition may be such that said carrier particles have a volume average particle size of between 30 to 65 μm, and said carrier particles comprise a core particle coated with a resin in an amount of 0.4 to 2.5% by weight, and the absolute charge expressed as fC/10 um (q/d) is between 3 and 13 fC/10 um.

The invention also covers a method of fusing and curing dry toner particles according to the invention, wherein the toner particles are image wise deposited on a substrate, said toner particles are then fused onto said substrate, and finally the fused toner particles are cured by means of radiation. Preferably, radiation is UV light, and said toner particles comprise one or more photoinitiators. In a preferred embodiment the fusing and curing is done in-line.

The invention also covers an apparatus for forming a toner on a substrate comprising: i) means for supplying dry toner particles, ii) means for image-wise depositing said dry toner particles on said substrate, iii) means for fusing said toner particles on said substrate, and iv) means for off-line or in-line radiation curing said fused toner particles according to the invention and wherein the substrate is fed by a web.

The invention encompasses substrates covered, e.g. coated or preferably printed with the dry toner particles according to the invention. To complete the substrate the toner particles are fixed and cured.

### DETAILED DESCRIPTION OF THE INVENTION

The present invention will be described with respect to particular embodiments but the invention is not limited thereto but only by the claims. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

To obtain a good curing efficiency one can adjust the curing power and/or increase the reactivity of the radiation curable toner

According to the present invention, the curing efficiency is measured by the ERN number i.e. the equivalent rub number being defined as:

ERN=MEK rub resistance/(radiation dose*meq/gr)

The ERN number gives a normalized rub number taking into account the radiation (e.g. UV) dose that is applied at curing and the reactivity of the binder resin used as the curable component of the toner.

The reactivity of the binder resin is expressed as the amount milli-equivalent of double bounds per gram (meq/gr) of the radiation curable resin or polymer present in the dry toner particles. This number can be calculated from the resin composition or analytically determined by the use of e.g. NMR or IR techniques standard in the polymer art. A higher curing power (dose) will result in better curing efficiency however there are some limitations. By increasing the UV power the power consumption will become higher and is from an economical viewpoint less interesting. Also by increasing the UV power the amount of IR present in the irradiated light will increase and can cause irreparable damage such as shrinkage or wrinkling of the substrate. For higher UV powers also a yellowing of substrate can occur especially when paper is used. Preferably the maximum UV power is 250 W/cm and more preferably 200 W/cm.

This means that for an improved curing efficiency also the toner formulation has to be optimized.

Adjusting the toner composition can be done by the choice of the radiation curable resin and (when UV light is used as the radiation) the type and concentration of the photoinitiator.

The curing of the radiation curable toner can be improved by increasing the concentration of photo initiator however this increase will have some drawbacks. Depending on the type of photoinitiator a drop in Tg is observed resulting in a toner with a too low Tg. This low Tg toner can have a bad storage stability and increased formation of agglomerates during development. Also above a certain concentration the curing will not further be improved. A possible explanation could be that too much material of a too low molecular weight is formed during the cross linking. Another drawback of a high photo initiator concentration is the possibility that a higher amount of unused photoinitiator is still present in the toner. Therefore, a photo initiator concentration between 0.5 and 6% is used, more preferably between 1 and 4%.

Due to the limitations of UV dose and photo initiator concentration a proper choice of UV curable resin is advisable to obtain a high curing performance. The most logical way is to increase the reactivity of the binder but it has been found that the number of double bounds cannot be increased an an unlimited manner because the binder can become so reactive that during the preparation an interaction can occur between the binder and the photo initiator resulting in an unstable viscosity behaviour.

On the other hand it has been observed surprisingly that not only the total number of double bounds is important but that combinations or blends of different types of radiation curable binders can result in toners with a higher curing efficiency than what could be expected from the total reactivity as expressed by the number of double bounds. The reason for this is not completely clear but, without being limited by theory, has maybe to do with the reactivity of each type of double bound on itself and in a copolymerization with other types of double bounds.

It has been found that a certain minimum level of reactivity is preferable in order to have a good curing result on different types of substrates and with different types of layer thickness and different types of pigments. Although the reactivity is important, the number of itself is certainly not a guarantee for a good final result. Nevertheless it has been found that a reactivity is preferably higher than 1.0 meq/g and more preferably higher than 1.15 meq/g.

The toner particles according to the present invention may comprise the radiation curable resins (radiation curable compounds or compositions) that preferably are UV-curable resins as sole toner resin, or the radiation curable resins may be mixed with other toner resins. In that case any toner resin known in the art may be useful for the production of toner particles according to this invention. The resins mixed with the radiation curable resins can be poly condensation polymers (e.g. polyesters, polyamides, co(polyester/polyamides), etc), epoxy resins, addition polymers or mixtures thereof.

Although electron beam curable compounds can be used in the present invention, the radiation curable groups are preferably cured by UV-light.

Useful UV curable resins for incorporation in toner particles, according to an aspect of this invention are toners based on (meth)acryloyl containing polyester. The term polyester includes all polymers with a backbone structure based on a polycondensation of an alcohol, preferably one or more polyols having 2 to 5 hydroxyl groups) and a carboxylic acid-containing compound. Examples of such UV curable resins are unsaturated polyesters based on terephtalic and/or isophtalic acid as the carboxylic acid-containing component, and on neopentylglycol and/or trimethylolpropane as the polyol component and whereon afterwards an epoxy-acrylate such as glycidyl (meth)acrylate may be attached. These polymers are available for instance from UCB Chemicals under the tradename Uvecoat. Another UV curable resin is a polyester-urethane acrylate polymer which may be obtained by the reaction of an hydroxyl-containing polyester, a polyisocyanate and a hydroxy-acrylate. Another binder system useful in the present invention, e.g. a toner, is composed of a mixture of an unsaturated polyester resin in which maleic acid or fumaric acid is incorporated and a polyurethane containing a vinylether available from DSM Resins under the tradename Uracross.

In a preferred embodiment, the glass transition temperature of said polymers is above 45° C. and the Tg of the toner is higher than 40° C.

For the UV curing to proceed it is preferable that one or more photoinitiators are present. Very useful photoinitiators in the context of this invention include, but are not limited to, compounds such as shown in the formulae I, II and III below, or mixtures of these compounds. Commercially available photoinitiators are available from Ciba Geigy under the tradename Irgacure.

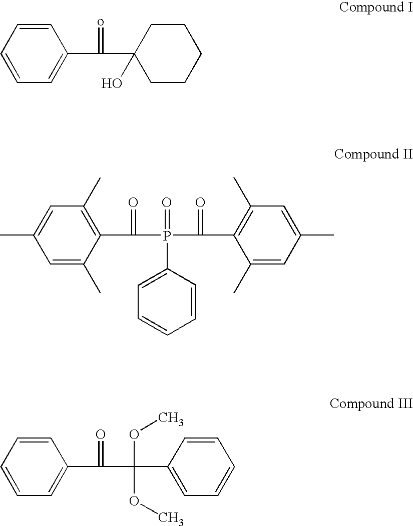

Compound I is available as Irgacure 184, compound II as lragcuer 819 and compound III as Irgacure 651.

The photoinitiator is preferably incorporated in the toner particles together with the UV curable system in a concentration range of preferably 1-6% by weight. If the concentration of the photoinitiator exceeds about 6% by weight, the Tg of the system can become too low.

Toner particles according to the present invention can be prepared by any method known in the art. For example, these toner particles can be prepared by melt kneading the toner ingredients (e.g. toner resin(s), charge control agent(s), pigment(s), etc) and said radiation curable compounds. After the melt kneading the mixture is cooled and the solidified mass is pulverized and milled and the resulting particles classified. Also other techniques to produce toners, e.g. floculation techniques and techniques to produce so called chemically produced toners, prepared via “emulsion polymerisation” and “polymer emulsion”, can be used with this invention. Also the shape of the toner particles can be adjusted/established by mechanical or chemical means or via a dedicated temperature treatment. Dissolving these resins into an organic solvent, mixing these with pigments and/or waxes and/or charge controlling agents, diluting the result through the addition of water and surfactants and creating in such a way round shaped UV curable toners can also be used.

Toner particles useful in this invention can have an average volume diameter (size) between about 3 and 20 μm. When the toner particles are intended for use in colour imaging, it is preferred that the volume average diameter is between 4 and 12 μm, most preferred between 5 and 10 μm. The particle size distribution of said toner particles can be of any type. It is however preferred to have an essentially (some negative or positive skewness can be tolerated, although a positive skewness, giving less smaller particles than an unskewed distribution, is preferred) Gaussian or normal particle size distribution, either by number or volume, with a coefficient of variability (standard deviation divided by the average) (v) smaller than 0.5, more preferably of 0.3.

Toner particles, useful in this invention, can comprise any normal toner ingredient e.g. charge control agents and charge levelling agents, colouring agents e.g. pigments or dyes both coloured and black, inorganic fillers, anti-slip agents, flowing agents, waxes, etc.

Positive and negative charge control agents can be used in order to modify or improve the triboelectric chargeability in either negative or positive direction. Very useful charge control agents for providing a net positive charge to the toner particles are nigrosine compounds (more particularly Bontron N04, trade name of Orient Chemical Industries—Japan) and quaternary ammonium salts. Charge control agents for yielding negative chargeable toners are metal complexes of salicylate (e.g. Bontron E84 or E88 from Orient Chemical Industries and Spielon Black TRH from Hodogaya Chemicals), and organic salts of an inorganic polyanion (Copycharge N4P, a trade name from Clariant). A description of charge control agents, pigments and other additives useful in toner particles, to be used in a toner composition according to the present invention, can be found in e.g. EP-601,235-B1.

Toners for the production of colour images may contain organic dyes/pigments of for example the group of phtalocyanine dyes, quinacidrone dyes, triaryl methane dyes, sulphur dyes, acridine dyes, azo dyes and fluoresceine dyes. Also TiO2 or BaSO4 can be used as a pigment to produce white toners. In order to obtain toner particles with sufficient optical density in the spectral absorption region of the colourant, the colourant is preferably present therein in an amount of at least 1% by weight with respect to the total toner composition. To improve the distribution of the colourant in the toner resin, it may be beneficial to add a so-called master batch of the colourant during the toner preparation instead of adding the pure colourant. The master batch of the colourant is prepared by dispersing a relatively high concentration of the colourant, present as pure pigment or as press cake, preferably ranging from 20 to 50% by weight in a resin, that does not need to be the radiation curable polymer, e.g. a polyester. The same master batch techniques can also be used for dispersing charge control agents and photo initiators.

The toner particles can be used as mono-component developers, both as a magnetic and as a non-magnetic mono-component developer. The toner particles can be used in a multi-component developer wherein both magnetic carrier particles and toner particles are present or in a trickle type development where both toner and carrier are added to the developer system with simultaneous removal of a part of the developer mixture. The toner particles can be negatively charged as well as positively charged.

Carrier particles can be either magnetic or non-magnetic. Preferably, the carrier particles are magnetic particles. Suitable magnetic carrier particles have a core of, for example, iron, steel, nickel, magnetite, γ—Fe₂O₃, or certain ferrites such as for example CuZn and environmental friendly ferrites with Mn, MnMg, MnMgSr, LiMgCa and MnMgSn. These particles can be of various shapes, for example, irregular or regular shape. Generally these carrier particles have a median particle size between 30 and 65 μm. Exemplary non-magnetic carrier particles include glass, non-magnetic metal, polymer and ceramic material. Non-magnetic and magnetic carrier particles can have similar particle size. Preferably the carrier core particles are coated or surface treated with diverse organic or inorganic materials or resins in a concentration of 0.4 to 2.5% to obtain, for example, desirable electrical, tribo electrical and/or mechanical properties.

In the two-component developer the amount of UV curable toner particles can be, for example, between about 1 and about 10 weight % (relative to the amount of developer).

Triboelectric charging of the toner particles proceeds in so-called two component developer mixtures by means of the carrier particles. Charging of individual toner particles through triboelectricity is a statistical process, which will result in a broad distribution of charge over the number of toner particles in the developer. If a relative large amount of toner particles have a charge too low for providing a sufficiently strong Coulomb attraction, the development of such kind of developer results in undesirable image-background fog. To avoid such fog in the printed image, the distribution of charge/diameter (q/d) of the toner particles is preferably in the range from an absolute value of 3 to 13 fC/10 μm as measured with a q/d meter from Dr R Epping PES Laboratorium 8056 Neufahrn.

Any suitable substrate can be used to print the UV curable toner on. For example it can be paper, plastic and/or metal foils and combinations of them in different thicknesses.

The paper substrate can have a smooth surface, may have a glossy finish, can be coloured or uncoloured and weighs for example 10 to 300 mg/cm².

Multilevel materials can be made out of two or more foil layers, e.g. paper, plastics and/or metal foils.

Examples of metal foils as substrates are foils from iron, steel, and copper and preferentially from aluminium and its alloys.

Suitable plastics are e.g. polyvinyl chloride (PVC), polyvinylidene chloride (PVDC), polyester, polycarbonates, polyvinyl acetate, polyolefins and particularly polyethylenes (PE), like polyethylene of high density (HDPE), polyethylene of middle density (MDPE), linear polyethylene-middle density (LMDPE), polyethylene low-density (LDPE) and linear low density polyethylene (LLDPE).

The thickness of the substrates can range from e.g. of 5 μm until 1000 μm, preferably 15 till 200 μm. For papers, coated on one side with plastic or metal foil, the thickness can vary from 5 till 500 μm, preferably 30 to 300 μm. The thickness of plastic foils can range from 8 to 1000 μm thick. Metal foils can exhibit a thickness from 5 to 300 μm.

The substrate can be fed by means of a web, preferably for thin substrates in order to avoid jams, or by means of sheets.

The present invention also includes a method for forming a toner image on a substrate comprising the steps of:
i) image-wise depositing coloured toner particles comprising a radiation curable resin on said substrate,
ii) fusing said toner particles on said substrate and
iii) radiation curing said fused toner particles.

In a preferred embodiment the image wise deposition on said substrate is done by image wise developing a latent image on a photoconductor and transferring said developed toner image by an intermediate means or directly to the substrate. The toner particles may be any of the toner particles defined by the present invention.

The radiation curing can proceed in line or off line.

Inline curing means that the curing proceeds in the fusing station of the apparatus itself (e.g. with the use of UV-light transparent fuser rollers) or in a station immediately adjacent to said fusing station.

The radiation curing can also proceed off-line in a separate apparatus. In this case the fused toner images are first stacked or rewind before feeding it again to the curing station. It can be beneficial that the fused toner is reheated again so that the toner layer becomes again in a molten state before the radiation (UV) curing proceeds.

Preferably said radiation curing proceeds at a temperature that preferably is at most 150° C. Therefore it is preferred to use toner particles, comprising a radiation curable compound having a Tg≧45° C., that have a melt viscosity at 120° C. between 50 and 3000 Pa·s, preferably between 100 and 2000 Pa·s.

The present invention further includes an apparatus for forming a toner image on a substrate comprising:
i) means for image-wise depositing toner particles comprising a radiation curable resin on said substrate,
ii) means for fusing said toner particles on said substrate
iii) means for off-line or in-line radiation curing said fused toner particles.

In a preferred apparatus according to this invention, the substrate is fed from web.

Said means for fusing said toner particles to the substrate can be any means known in the art, the means for fusing toner particles according to this invention can be contact (e.g. hot-pressure rollers) or non-contact means. Non-contact fusing means according to this invention can include a variety of embodiments, such as: (1) an oven heating process in which heat is applied to the toner image by hot air over a wide portion of the support sheet, (2) a radiant heating process in which heat is supplied by infrared and/or visible light absorbed in the toner, the light source being e.g. an infrared lamp or flash lamp. According to a particular embodiment of “non-contact” fusing the heat reaches the non-fixed toner image through its substrate by contacting the support at its side remote from the toner image with a hot body, e.g., a hot metallic roller. In the present invention, non-contact fusing by radiant heat, e.g., infrared radiation (IR-radiation), is preferred. In a contact fusing process, the non-fixed toner images on the substrate are contacted directly with a heated body, i.e. a so-called fusing member, such as fusing roller or a fusing belt. Usually a substrate carrying non-fixed toner images is conveyed through a nip formed by establishing a pressure contact between said fusing member and a backing member, such as a roller. To obtain high quality images, it is recommended to use hot roller systems with a low amount of release agents.

In a apparatus according to the present invention it is preferred to use toner particles comprising a UV-curable resin and thus the means for radiation curing the toner particles comprise are means for UV-curing (UV-light emitters as e.g. UV lamps). In an apparatus according to the present invention, it is preferred that the radiation curing proceeds inline. Therefore it is preferred that said means for fusing said toner images emit infrared radiation (are infra-red radiators) and said means for UV curing (e.g. one or more UV emitting lamps) are installed immediately after said fusing means so that the UV curing proceed on the still molten toner image. Different techniques exist for activating the UV lamps: UV lamps powered by microwave technology or arc lamps. Different types of UV lamps can be used and the choice of the type of UV lamp that will be used, i.e. V, D, F bulb, will depend on the toner formulation and on the type of photo initiator that is used. A proper match between the emission spectrum of the UV lamp and the absorption spectra of the used photo initiator is recommended to obtain an efficient curing. A combination of infra-red radiators (the means for fusing the toner particles) and UV emitting lamps (the means for radiation curing) in a single station (a fixing/curing station), so that the fusing and the radiation curing proceed simultaneously, is also a desirable design feature of an apparatus according to this invention. The apparatus according to the present invention can comprise if so desired, more than one fixing/curing station. The UV emitting means are preferably UV radiators with a UV power between 25 W/cm and 250 W/cm in order that the UV curing is done with at most 30 J/cm².

The means for image-wise depositing toner particles can, in apparatus according to this invention, also be direct electrostatic printing means (DEP), wherein charged toner particles are attracted to the substrate by an electrical field and the toner flow modulated by a print head structure comprising printing apertures and control electrodes.

Said means for image-wise depositing toner particles can also be toner depositing means wherein first a latent image is formed. In such an apparatus, within the scope of the present invention, said means for image-wise depositing toner particles comprise:
i) means for producing a latent image on a latent image bearing member,
ii) means for developing said latent image by the deposition of said toner particles, forming a developed image and
iii) means for transferring said developed image on said substrate.

Said latent image may be a magnetic latent image that is developed by magnetic toner particles (magnetography) or, preferably, an electrostatic latent image. Such an electrostatic latent image is preferably an electrophotographic latent image and the means for producing a latent image are in this invention preferably light emitting means, e.g., light emitting diodes or lasers and said latent image bearing member comprises preferably a photoconductor.

The present invention also comprises a substrate covered by the dry toner particles according to the present invention.

The following examples are provided for a better understanding of the invention and for illustrative purposes only, and should in no way be construed as limiting the scope of this invention.

Test methods

Melt viscosity

The melt viscosity is measured in a CSL2 500 Carr-Med Rheometer from TA Instruments The viscosity measurement is carried out at a sample temperature of 120° C. and 140° C. The sample having a weight of 0.75 g is applied in the measuring gap (about 1.5 mm) between two parallel plates of 20 mm diameter one of which is oscillating about its vertical axis at 6 rad/sec and amplitude of 10⁻³ radians. The sample is temperature equilibrated for 10 min at 120 and 140° C. respectively

The viscosity behaviour is ranked as follows:

1 excellent: viscosity at 140° C. is lower than at 120° C.

3 acceptable: viscosity at 140° C. is equal to slightly higher than viscosity at 120° C.

5=bad: viscosity at 140° C. is higher than at 120° C. and viscosity at 120° C. is already too high (>5,000 Pa·s).

MEK Rub Resistance Test

With a cotton path 4-4931 from AB Dick sucked with MEK (methylethyl ketone) the fused and cured toner images re rubbed with a pressure between 100 and 300 g/cm2. One count is equal to an up and down rub. The image that is rubbed has an applied mass of 0.6 mg/cm².

The rubs are counted till the substrate becomes visible. The number of rubs is a measure for the solvent resistance of the toner images

The toners are deposited on an uncoated 135 gsm paper (Modo Diane data copy option from M-reel) and fused for 7 minutes at 135° C. in an oven.

ERN (Equivalent Rub Number)

The ERN number is determined as:

ERN=MEK rub resistance/(radiation dose*meq/gr), i.e. when the radiation used for curing is UV light, the ERN number is determined as:

ERN=MEK rub resistance/(UV dose*meq/gr), whereby the UV dose is preferably within a range between 3 and 30 J/cm² and (for UV light) an iron doped mercury lamp is used, and wherein the substrate used for developing the toner images is not preheated at the time of curing. A test like ERN>X means that the ERN is larger than X for curing tests with any UV dose taken within the above referred preferred radiation (e.g. UV) dose range. ERN_IR

The ERN_IR number is determined as
ERN_IR=MEK rub resistance/(radiation dose*meq/gr) i.e. when the radiation used for curing is UV light, the ERN number is determined as:
ERN_IR=MEK rub resistance/(UV dose*meq/gr) whereby the UV dose is preferably within a range between 3 and 30 J/cm² and (for UV light) an iron doped mercury lamp is used, and wherein the surface temperature of the substrate is heated between 100° C. and 160° C. at the time of curing.

The toner is in a molten state when it enters the curing apparatus and thus has a higher mobility and thus a better reactivity resulting in a higher MEK rub resistance) A test like ERN_IR>X means that the ERN is larger than X for curing tests with any UV dose taken in the given UV dose range.

### EXAMPLES

In the following, all parts mentioned are parts by weight The following ingredients were tested:*

TABLE 1

| | Commercial | | | |
|---|---|---|---|---|
| Ingredient | name | Description Xeikon | Description supplier | Meq/gr |
| UVP1 | Uvecoat 2100 | (Meth)acryloyl | (meth) acrylated polyester | 0.7 |
| | | containg polyester | resin | |
| | | based on terefphtalic | | |
| | | acid and neopentyl | | |
| | | glycol | | |
| UVP2 | Uvecoat 3000 | (Meth)acryloyl | (meth) acrylated | 0.9 |
| | | containg polyester | epoxy/polyester resin | |
| | | based on terefphtalic | | |
| | | acid and neopentyl | | |
| | | glycol | | |
| UVP3 | Alfalat VAN 1743 | Unsaturated polyester | Unsaturated polyester | .65 |
| | | resin | resin | |
| UVP4 | Uvecoat 9146 | Unsaturated urethane | (meth)acrylated | 2.2 |
| | | acrylic adduct | polyurethane resin | |
| UVP5 | Uracross | Maleic based | Maleic based polyester | 2.5 |
| | P3125(70%)- | polyester (70%) | (70%) | |
| | Uracross P3307 | Vinylether | Vinylether polyurethane | |
| | (30%) | polyurethane | copolymer (30% | |
| | | copolymer (30% | | |
| UVP6 | Almacryl T500 | Polyester based on | Polyester based on | 1.9 |
| | | fumaric acid and | fumaric acid and | |
| | | propoxylated | propoxylated bisphenol A | |
| | | bisphenol A | | |
| PI1 | Irgacure 819 | BAPO photoinitiator | BAPO photoinitiator | |
| PI2 | Irgacure 2959 | AHK photoinitiator | AHK photoinitiator | |
| PI3 | Irgacure 277 | N-containing | Alpha amino ketone | |
| | | photoinitiator | photoinitiator | |

The toners were prepared by melt blending for 30 minutes in a laboratory kneader at 110° C. the ingredients, together with 3% by weight of a phtalocyanine blue pigment, as mentioned in table 2. After cooling, the solidified mass was pulverized and milled using a Alpine Fliessbettgegenstrahlmuhle 100 AFG (trade name) and further classified using a multiplex zig-zag classifier type 100 MZR (trade name) to obtain a toner with a dv50 between 7 and 9 μm.

In order to improve the flowability of the toner, the particles were mixed with 0.5% of hydrophobic colloidal silica from Degussa.

Developers

From toners T1 to T10 developers were prepared by mixing 5 g of said toner particles together with 100 g of a coated silicone MnMgSr ferrite carrier with a dv50 of 45 μm.

From toners T11 to T19 developers were prepared by mixing 5 g of said toner particles together with 100 g of a coated silicone CuZn ferrite carrier with a dv50 of 45 to 55 μm

Images were developed with an applied mass of 0.6 mg/cm2 on uncoated 135 gsm paper and fused at 135° C. for 7 min in an oven.

The toner images were UV cured as mentioned in table 3 and table 4. The curing results in table 4 are obtained by first heating again by IR the fused samples where the results in table 3 are based on curing without IR heating. No IR heating means that the substrate temperature measured with a Raytek infrared gun is lower than 80° C. just before entering the curing station.

TABLE 2
toner composition

| | | | | | | | [Photo | [photo | | | |
|---|---|---|---|---|---|---|---|---|---|---|---|
| | | | [polymer | [polymer | | | initiator | initiator | | Viscosity | |
| Toner | Polymer 1 | Polymer 2 | 1] | 2] | Photoinitiator a | Photoinitiator b | a] | b] | Meq/g | behaviour | Tg |
| T1 | UVP1 | | 100 | | PI1 | | 3 | | 0.7 | 1 | 1 |
| T2 | UVP2 | | 100 | | PI1 | | 3 | | 0.9 | 1 | 2 |
| T3 | UVP4 | | 100 | | PI1 | | 3 | | 2.2 | 5 | 1 |
| Tt4 | UVP5 | | 100 | | PI1 | | 3 | | 2.5 | 1 | 5 |
| T5 | UVP2 | | 100 | | PI2 | | 3 | | 0.9 | 1 | 4 |
| T6 | UVP2 | | 100 | | PI3 | | 3 | | 0.9 | 1 | 2 |
| T7 | UVP2 | | 100 | | PI1 | PI2 | 1 | 1.5 | 0.9 | 1 | 3 |
| T8 | UVP1 | UVP4 | 87.5 | 12.5 | PI1 | | 3 | | 0.9 | 1 | 1 |
| T9 | UVP1 | UVP4 | 75 | 25 | PI1 | | 3 | | 1.08 | 2 | 1 |
| T10 | UVP1 | UVP4 | 62.5 | 37.5 | PI1 | | 3 | | 1.26 | 3 | 1 |
| T11 | UVP1 | UVP4 | 50 | 50 | PI1 | | 3 | | 1.45 | 4 | 1 |
| T12 | UVP2 | UVP4 | 87.5 | 12.5 | PI1 | | 3 | | 1.06 | 1 | 2 |
| T13 | UVP2 | UVP4 | 75 | 25 | PI1 | | 3 | | 1.23 | 1 | 1 |
| T14 | UVP2 | UVP4 | 62.5 | 37.5 | PI1 | | 3 | | 1.39 | 3 | 1 |
| T15 | UVP2 | UVP4 | 75 | 25 | PI1 | PI2 | 1 | 1.5 | 1.23 | 1 | 1 |
| T16 | UVP2 | UVP4 | 75 | 25 | PI1 | | 1 | | 1.23 | 1 | 1 |
| T17 | UVP2 | UVP4 | 75 | 25 | PI2 | | 1.5 | | 1.23 | 1 | 1 |
| T18 | UVP3 | UVP4 | 70 | 30 | PI1 | | 3 | | 1.04 | 2 | 2 |
| T19 | UVP6 | | 100 | | PI1 | | 3 | | 1.9 | 1 | 2 |

TABLE 3
curing results without IR heating

| ex- | | Inv/ | | UV | MEK rub | ERN | Viscosity |
|---|---|---|---|---|---|---|---|
| amples | toner | com | Meq/gr | dose | resistance | number | behaviour |
| Ex1 | T12 | Inv | 1.06 | 17 | 200 | 11.1 | 1 |
| Ex2 | T16 | Inv | 1.23 | 17 | 275 | 13.2 | 1 |
| Ex3 | T17 | Inv | 1.23 | 17 | 335 | 16 | 1 |
| Ex4 | T13 | Inv | 1.23 | 17 | 470 | 22.5 | 1 |
| Ex5 | T14 | Inv | 1.39 | 17 | 1344 | 56.9 | 3 |
| Ex6 | T2 | Com | 0.9 | 17 | 60 | 3.9 | 1 |
| Ex7 | T4 | com | 2.5 | 17 | 38 | 0.9 | 1 |

TABLE 4
curing results with IR heating

| ex- | | Inv/ | | UV | MEK rub | ERN | Viscosity |
|---|---|---|---|---|---|---|---|
| amples | toner | com | Meq/gr | dose | resistance | number | behaviour |
| Ex8 | T19 | Com | 2.1 | 17 | 22 | 0.7 | 1 |
| Ex9 | T1 | Com | 0.7 | 17 | 12 | 1 | 1 |
| Ex10 | T4 | Com | 2.5 | 17 | 45 | 1.1 | 1 |
| Ex11 | T8 | Com | .9 | 17 | 20 | 1.3 | 1 |
| Ex12 | T9 | Com | 1.08 | 17 | 40 | 2.2 | 2 |
| Ex13 | T18 | Com | 1.04 | 17 | 55 | 3.1 | 2 |
| Ex14 | T6 | Com | 0.9 | 17 | 50 | 3.3 | 1 |
| Ex15 | T5 | Com | 09 | 17 | 55 | 3.6 | 1 |
| Ex16 | T10 | Com | 1.26 | 17 | 80 | 3.7 | 3 |
| Ex17 | T2 | Com | 0.9 | 17 | 70 | 4.6 | 1 |
| Ex18 | T2 | Com | 0.9 | 8.5 | 50 | 6.5 | 1 |
| Ex19 | T7 | Com | 0.9 | 17 | 110 | 7.2 | 1 |
| Ex20 | T15 | Inv | 1.23 | 8.5 | 130 | 12.4 | 1 |
| Ex21 | T12 | Inv | 1.06 | 17 | 290 | 16.1 | 1 |
| Ex22 | T11 | Com | 1.45 | 17 | 440 | 17.8 | 4 |
| Ex23 | T13 | Inv | 1.23 | 4.25 | 120 | 23 | 1 |
| Ex24 | T17 | Inv | 1.23 | 17 | 490 | 23.4 | 1 |
| Ex25 | T16 | Inv | 1.23 | 17 | 500 | 23.9 | 1 |
| Ex26 | T13 | Inv | 1.23 | 17 | 672 | 32.1 | 1 |
| Ex27 | T15 | Inv | 1.23 | 12 | 490 | 33.2 | 1 |
| Ex28 | T13 | Inv | 1.23 | 12 | 490 | 33.2 | 1 |
| Ex29 | T16 | Inv | 1.23 | 8.5 | 350 | 33.5 | 1 |
| Ex30 | T17 | Inv | 1.23 | 4.25 | 180 | 34.4 | 1 |
| Ex31 | T13 | Inv | 1.23 | 8.5 | 360 | 34.4 | 1 |
| Ex32 | T15 | Inv | 1.23 | 17 | 790 | 37.8 | 1 |
| Ex33 | T15 | Inv | 1.23 | 4.25 | 200 | 38.3 | 1 |
| Ex34 | T17 | Inv | 1.23 | 8.5 | 450 | 43 | 1 |
| Ex35 | T3 | Com | 2.2 | 17 | 3000 | 80 | 5 |
| Ex36 | T14 | Inv | 1.39 | 17 | 2790 | 118.1 | 3 |
| Ex37 | T13 | Inv | 1.23 | 24 | 640 | 22 | 1 |

Results

From the data in table 2, it can be learned that by increasing the reactivity of the resin, the viscosity behaviour can becomes worse (see t3, t10, t 11 and t14) and that photo initiator P12 causes a drop in Tg. (see t5) Also the Tg of the toner based on UVP5 is too low which cause the formation of agglomerations during the activation in the developing unit.

From table 4 we learn that toners with the same reactivity can have ERN_IR numbers going from too low (<10) for a proper curing to a ERN number resulting in a very high performance cure (>10) (see ex12-ex21; ex13-ex21; ex 16-ex26)

What also clearly can be observed from table 4 is that with toners based on a blend of UPV2 and UVP 4 in a ratio 75/25 a large latitude in curing performance is present with respect to type and concentration of photoinitiator and to the applied UV dose. (see ex20; ex 23 to ex 34; ex 37).

In an embodiment of the present invention the above examples can be applied for printing to any suitable substrate such as paper, cardboard; e.g. packaging, plastic foils, ceramics, etc. using a suitable printer such as for instance a Xeikon 5000 Printer.

In a further embodiment of the present invention an apparatus is provided for forming a toner on a substrate comprising:
i) means for supplying dry toner particles,
ii) means for image-wise depositing said dry toner particles on said substrate,
iii) means for fusing said toner particles on said substrate, and
iv) means for off-line or in-line radiation curing said fused toner particles,
   wherein said dry toner particles are in accordance with the present invention, e.g. are the examples of toner particles described above and wherein the substrate is fed by a web. A suitable printer is the Xeikon 5000 printer.

1-23. (canceled)

24. Dry toner particles comprising at least a blend of radiation curable resins and a colouring agent, wherein said blend comprises (a) a (meth)acrylated epoxy/polyester resin and (b) a (meth)acrylated polyurethane resin.

25. Dry toner particles according to claim 24, wherein when fused and cured toner images obtainable from said dry toner particles are obtained on a substrate used for developing same, these images have an equivalent rub number (ERN)>6, wherein ERN=MEK rub resistance/(radiation dose*meq/gr), wherein meq/gr designates the milli-equivalent amount of double bounds per gram of said radiation curable resin.

26. Dry toner particles according to claim 24, wherein said (meth)acrylated expoxy/polyester resin (a) is based on terephthalic acid and neopentyl glycol.

27. Dry toner particles according to claim 24, wherein said radiation curable resin is an electron-beam curable resin.

28. Dry toner particles according to claim 24, wherein said radiation curable resin is a UV-light curable resin, and wherein said toner particles further comprise one or more photoinitiators.

29. Dry toner particles according to claim 24, further comprising a flowability improving agent.

30. Dry toner particles according to claim 24, wherein the milli-equivalent amount of double bounds per gram of said radiation curable resin is >1 meq/gr.

31. Dry toner particles according to claim 24, having a volume average diameter between 3 and 20 μm.

32. Dry toner particles according to claim 24, wherein the viscosity of the toner particles is between 50 and 5,000 Pa·s at 120° C.

33. Dry toner particles according to claim 24, wherein the MEK rub resistance of the cured toner images obtainable from said dry toner particles is higher than 100 rubs.

34. Dry toner particles according to claim 24, wherein the blend ratio (a)/(b) varies between 92.5/7.5 and 50/50.

35. A dry electrostatographic developer composition comprising carrier particles and dry toner particles comprising at least a blend of radiation curable resins and a colouring agent, wherein said blend comprises (a) a (meth)acrylated epoxy/polyester resin and (b) a (meth)acrylated polyurethane resin.

36. A dry electrostatographic developer composition according to claim 35, wherein the blend ratio (a)/(b) varies between 92.5/7.5 and 50/50.

37. A dry electrostatographic developer composition according to claim 35, wherein:
said carrier particles have a volume average particle size of between 30 to 65 μm, and
said carrier particles comprise a core particle coated with a resin in an amount of 0.4 to 2.5% by weight, and
the absolute charge expressed as fC/10 um (q/d) is between 3 and 13 fC/10 μm.

38. A method of fusing and curing dry toner particles comprising at least a blend of radiation curable resins and a colouring agent, wherein said blend comprises (a) a (meth)acrylated epoxy/polyester resin and (b) a (meth)acrylated polyurethane resin, wherein:
said toner particles are image wise deposited on a substrate,
said toner particles are then fused onto said substrate, and
finally the fused toner particles are cured by means of radiation.

39. A method according to claim 38, wherein said radiation is UV light, and wherein said toner particles comprise one or more photoinitiator.

40. A method according to claim 38, wherein the blend ratio (a)/(b) varies between 92.5/7.5 and 50/50.

41. An apparatus for forming a toner on a substrate comprising:
(i) means for supplying dry toner particles comprising at least a blend of radiation curable resins and a colouring agent, wherein said blend comprises (a) a (meth)acrylated epoxy/polyester resin and (b) a (meth)acrylated polyurethane resin,
(ii) means for image-wise depositing said dry toner particles on said substrate,
(iii) means for fusing said toner particles on said substrate, and
(iv) means for off-line or in-line radiation curing said fused toner particles,
wherein said substrate is fed by a web.

42. An apparatus for forming a toner on a substrate according to claim 41, wherein the blend ratio (a)/(b) varies between 92.5/7.5 and 50/50.

43. A substrate printed with dry toner particles comprising at least a blend of radiation curable resins and a colouring agent, wherein said blend comprises (a) a (meth)acrylated epoxy/polyester resin and (b) a (meth)acrylated polyurethane resin, wherein said dry toner particles are fixed and cured.
